(19) United States
(12) Patent Application Publication
(10) Pub. No.: US 2016/0227796 A1
(43) Pub. Date: Aug. 11, 2016

(54) PROCESS FOR PRODUCING FROZEN FISH MEAT AND SYSTEM FOR PRODUCING THE SAME, AND FROZEN RED FISH MEAT

(71) Applicant: MAYEKAWA MFG. CO., LTD., Tokyo (JP)

(72) Inventors: Shinji KONO, Tokyo (JP); Madoka KON, Tokyo (JP); Hayato USAMI, Tokyo (JP); Toshio OMURA, Tokyo (JP)

(73) Assignee: MAYEKAWA MFG. CO., LTD., TOKYO (JP)

(21) Appl. No.: 15/024,030

(22) PCT Filed: Aug. 29, 2014
(86) PCT No.: PCT/JP2014/072673

§ 371 Date: Mar. 22, 2016

(30) Foreign Application Priority Data
Sep. 26, 2013 (JP) 2013-200632

(51) Int. Cl. A23B 4/07; F25D 13/06; A23B 4/06

(52) U.S. Cl. CPC A23B 4/07; A23L 1/325; A23B 4/062; F25D 13/067

(57) ABSTRACT

The process for producing a frozen fish meat for producing a frozen red fish meat, includes: a freezing step of cooling a red fish meat and freezing a whole of the red fish meat including a superficial layer and an inner core part; a superficial layer thawing step of heating the red fish meat frozen in the freezing step from an outer side to thaw the superficial layer of the red fish meat; and a refreezing step of stopping heating the red fish meat after the superficial layer is thawed in the superficial layer thawing step, and then refreezing the superficial layer of the red fish meat at a lower freezing speed than a freezing speed in the freezing step.

### TECHNICAL FIELD

The present disclosure relates to a process and a system for producing a frozen fish meat for producing a frozen red fish meat, and a frozen red fish meat.

### BACKGROUND

Heretofore, frozen fish meat obtained by freezing fish meat is widely distributed as it can be stored for a long period of time as food. Recently, freezing techniques for producing frozen product have been improved, and it is known that the freezing quality can be well maintained particularly by rapid freezing. That is, in order to prevent tissue destruction due to formation or growth of ice crystal, rapid freezing is performed such that the temperature goes through the temperature zone of maximum ice crystal formation in a short time, whereby the ice crystal becomes smaller and destruction of or damage to the cellular tissues due to freezing can be prevented, and thus it is possible to provide a frozen product of a high freezing quality.

For example, Patent Document 1 and 2 disclose various freezing techniques. Patent Document 1 discloses a freezing method where cool air is injected to a food to be frozen conveyed by a conveyer to rapidly freeze the food. Patent Document 2 discloses a method of cooling a liquid food filled in a mold to an extent such that the fluid food is not frozen, and then heating the fluid food so that the fluid food is removed from the mold, and then freezing the fluid food, although this technique is not limited to the rapid freezing.

Further, Patent Document 3 discloses a method for quality evaluation where the quality evaluation of a frozen food is carried out on the basis of the color of the surface of the frozen food in order to further improve the freezing quality. Patent Document 3 also discloses a method for operating control of a freezing apparatus on the basis of the evaluation results.

### CITATION LIST

### Patent Literature

Patent Document 1: JP 2004-45035 A

Patent Document 2: JP 2007-110911 A

Patent Document 3: JP 2008-2985 A

### SUMMARY

### Technical Problem

For some kinds of fish meat having red meat such as salmon, tuna or bonito, the quality evaluation in the marketing is usually influenced by the appearance color. For example, muscle of salmon has a characteristic red color due to carotenoid pigments including astaxanthin as a main ingredient. It is known that there is a relative correlation between the carotenoid pigments and the color of the muscle, and the color of the meat is regarded as one of important quality evaluation standards in the marketing, and one having a stronger red color is preferred. On the other hand, a frozen food having a good freezing quality has small ice crystals, and the appearance color tends to become cloudy or opaque. Thus, even when a high freezing quality is maintained by rapid freezing as disclosed in Patent Document 1 or 2, the quality may be evaluated as being worse than it actually is due to the clouding or opaquing of the red meat part.

In this regard, Patent Document 3 discloses a quality evaluation performed on the basis of the surface color of the frozen food, and operation control of a freezing apparatus by using the evaluation results. However, the evaluation in this context is evaluation in the freezing quality. Thus, the operation control method using the evaluation results is also a control for improving the freezing quality, and the document discloses nothing about a technique to improve the appearance color.

An object of at least an embodiment of the present invention is to provide a process and system for producing a frozen fish meat by which it is possible to improve the appearance color while maintaining the freezing quality of a red fish meat, and a frozen red fish meat.

### Solution to Problem

A process for producing a frozen fish meat according to at least an embodiment of the present invention is a process for producing a frozen fish meat for producing a frozen red fish meat, comprising: a freezing step of cooling a red fish meat and freezing a whole of the red fish meat including a superficial layer and a core part; a superficial layer thawing step of heating the red fish meat frozen in the freezing step from an outer side to thaw the superficial layer of the red fish meat; and a refreezing step of stopping heating the red fish meat after the superficial layer is thawed in the superficial layer thawing step, and then refreezing the superficial layer of the red fish meat at a lower freezing speed than a freezing speed in the freezing step.

In the present description, a “red fish meat” means a fish meat having a meat tinged with red or yellow color, such as salmon, tuna or bonito.

According to the above-described process for producing a frozen fish meat, it is possible to improve the appearance color while maintaining the freezing quality of the red fish meat. That is, in the above-described process for producing a frozen fish meat, after freezing the red fish meat in the freezing step, the superficial layer of the red fish meat is thawed in the superficial layer thawing step, and the superficial layer of the red fish meat if refreeze in the refreezing step. In the refreezing step, the superficial layer is refreeze at a lower freezing speed than the freezing speed in the freezing step. In the refreezing step, ice crystals in the superficial layer of the red fish meat which is once thawed grows larger than ice crystals in the inner portion at the inner side of the superficial layer. The clouding or opaquing of the superficial layer of the red fish meat may thereby be improved, and it is possible to bring the color of the frozen red fish meat closer to the actual meat color. It is thereby possible to improve the appearance color of the frozen red fish meat and to obtain proper evaluation in accordance with the quality of the actual fish meat in the marketing. Further, since only the superficial layer of the red fish meat is thawed in the superficial layer thawing step, it is possible to maintain the frozen state of the inner portion of the red fish meat and to maintain good freezing quality.

In some embodiments, in the superficial layer thawing step, warm air is blown to the superficial layer of the red fish meat to thaw the superficial layer.

It is thereby possible to effectively thaw the superficial layer of the red fish meat in a short time while maintaining the frozen state of the inner portion of the red fish meat.

In some embodiments, in the refreezing step, the superficial layer is refrozen by using a cold heat of an inner portion present on an inner side than the superficial layer of the red fish meat, without blowing cold air to the red fish meat.

By refreezing the superficial layer mainly by heat transfer of the cold heat from the inner portion of the red fish meat as described above, the superficial layer can easily be refrozen at a lower freezing speed than the freezing speed in the freezing step. Further, refreezing in a typical frozen food storage or refreezing in a temperature averaging step where averaging of the temperature of the frozen red fish meat is performed becomes possible, whereby the facility cost can be reduced.

In some embodiments, in the freezing step, cold air is blown to the red fish meat placed on a mesh belt made from a resin to rapidly freeze the red fish meat.

According to the above-described process, the cold air passes through the openings of the mesh belt and is blown directly to the red fish meat, whereby it is possible to increase the freezing speed.

If a mesh belt made from a metal is used, for example, print of the mesh may remain on the red fish meat at the time of rapid freezing as a metal has a high thermal conductivity. In the above-described embodiment, in contrast, the mesh belt made from a resin, which has a lower thermal conductivity than a metal, is used, whereby it is possible to avoid the mesh print remaining on the red fish meat at a side in contact with the mesh belt.

Further, it is easy to form the resin mesh belt to have a substantially flat contacting surface with the red fish meat. Thus, when the above-descried configuration is employed, it is possible to suppress generation of a concave or a convex due to the self-weight of the red fish meat.

In an embodiment, the process further comprises a freezing quality evaluation step of converting, with respect to an image of the red fish meat before freezing captured before the freezing step and an image of the red fish meat after freezing captured after the freezing step, respective values of the RGB color system to respective values of the L*a*b* color system, and evaluating a freezing quality of the red fish meat on the basis of the respective values of the L*a*b* color system.

By converting, with respect to images of the red fish meat before freezing and after freezing captured before and after the freezing step, respective values of the RGB color system representing the light-source color to respective values of the L*a*b* color system representing the object's color, and analyzing a change in the object's color on the basis of the respective values as described above, it is possible to properly evaluate the freezing quality of the red fish meat by using an objective index.

In an embodiment, the process comprises an appearance quality evaluation step of converting, with respect to an image of the red fish meat before freezing captured before the freezing step and an image of the red fish meat after refreezing captured after the refreezing step, respective values of the RGB color system to respective values of the L*a*b* color system, and evaluating an appearance quality of the red fish meat on the basis of the respective values of the L*a*b* color system.

By converting, with respect to an image of the red fish meat before freezing captured before the freezing step and an image of the red fish meat after refreezing captured after the refreezing step, respective values of the RGB color system representing the light-source color to respective values of the L*a*b* color system representing the object's color as described above, and analyzing a change in the object's color on the basis of the respective values, it is possible to properly evaluate the appearance quality of the red fish meat by using an objective index.

A method for improving an appearance color of a frozen fish meat according to at least an embodiment of the present invention is a method for improving an appearance color of a frozen red fish meat obtained by rapid freezing, and it comprises: a superficial layer thawing step of heating the red fish meat frozen wholly including a superficial layer and a core part from an outer side to thaw the superficial layer of the red fish meat; and a refreezing step of stopping heating the red fish meat after the superficial layer is thawed in the superficial layer thawing step, and then slowly refreezing the superficial layer of the red fish meat.

By the above-described method for improving an appearance color of a frozen fish meat, the appearance color can be improved while maintaining the freezing quality of the rapidly frozen red fish meat. That is, in the above-described method for improving an appearance color of a frozen fish meat, the superficial layer of the red fish meat is thawed in the superficial layer thawing step, and then the superficial layer of the red fish meat is slowly frozen in the refreezing step. It is thereby possible to improve the appearance color of the frozen red fish meat and to obtain proper evaluation in accordance with the quality of the actual fish meat in the marketing. Further, since only the superficial layer of the red fish meat is thawed in the superficial layer thawing step, it is possible to maintain the frozen state of the inner portion of the red fish meat and to maintain good freezing quality.

A system for producing a frozen fish meat according to at least an embodiment of the present invention is a system for producing a frozen red fish meat, and it comprises: a conveyer for conveying a red fish meat; a freezing part disposed on an upstream side on the conveyer, for cooling the red fish meat to freeze a whole of the red fish meat including a superficial layer and a core part; a superficial layer thawing part disposed on a downstream side of the freezing part on the conveyer, for heating the red fish meat from an outer side to thaw the superficial layer of the red fish meat; and a refreezing part for refreezing the superficial layer of the red fish meat thawed in the superficial layer thawing part at a lower freezing speed than a freezing speed in the freezing part.

According to the above-described system for producing a frozen fish meat, it is possible to improve the appearance color while maintaining the freezing quality of the red fish meat. That is, in the above-described system for producing a frozen fish meat, after freezing the red fish meat in the freezing step, the superficial layer of the red fish meat is thawed in the superficial layer thawing step, and the superficial layer of the red fish meat if refreeze in the refreezing step. In the refreezing step, the superficial layer is refreeze at a lower freezing speed than the freezing speed in the freezing step. In the refreezing step, ice crystals in the superficial layer of the red fish meat which is once thawed grows larger than ice crystals in the inner portion at the inner side of the superficial layer. The clouding or opaquing of the superficial layer of the red fish meat may thereby be improved, and it is possible to bring the color of the frozen red fish meat closer to the actual meat color. It is thereby possible to improve the appearance color of the frozen red fish meat and to obtain proper evaluation in accordance with the quality of the actual fish meat in the marketing. Further, since only the superficial layer of the red fish meat is thawed in the superficial layer thawing step, it is possible to maintain the frozen state of the inner portion of the red fish meat and to maintain good freezing quality.

In some embodiments, the superficial layer thawing part is configured to blow warm air to the superficial layer of the red fish meat to thaw the superficial layer.

It is thereby possible to effectively thaw the superficial layer of the red fish meat in a short time while maintaining the frozen state of the inner portion of the red fish meat.

In some embodiments, the refreezing part is configured to refreeze the superficial layer by using a cold heat of an inner portion present on an inner side than the superficial layer of the red fish meat, without blowing cold air to the red fish meat.

By refreezing the superficial layer mainly by heat transfer of the cold heat from the inner portion of the red fish meat as described above, the superficial layer can easily be refrozen at a lower freezing speed than the freezing speed in the freezing step. Further, refreezing in a typical frozen food storage or refreezing in a temperature averaging step where averaging of the temperature of the frozen red fish meat is performed becomes possible, whereby the facility cost can be reduced.

In some embodiments, the conveyer includes a mesh belt made from a resin, on which the red fish meat is placed, and the freezing part includes a cold air supply part for blowing cold air to the red fish meat placed on the mesh belt.

According to the above-described process, the cold air passes through the openings of the mesh belt and is blown directly to the red fish meat, whereby it is possible to increase the freezing speed.

If a mesh belt made from a metal is used, for example, print of the mesh may remain on the red fish meat at the time of rapid freezing as a metal has a high thermal conductivity. In the above-described embodiment, in contrast, the mesh belt made from a resin, which has a lower thermal conductivity than a metal, is used, whereby it is possible to avoid the mesh print remaining on the red fish meat at a side in contact with the mesh belt.

Further, it is easy to form the resin mesh belt to have a substantially flat contacting surface with the red fish meat. Thus, when the above-descried configuration is employed, it is possible to suppress generation of a concave or a convex due to the self-weight of the red fish meat.

In an embodiment, the system further comprises: a first capturing part disposed on an upstream side of the freezing part and configured to capture an image of the red fish meat before freezing; a second capturing part disposed on a downstream side of the freezing part and configured to capture an image of the red fish meat after freezing; and a freezing quality evaluating part configured to convert, with respect to an image of the red fish meat before freezing captured before the freezing step and an image of the red fish meat after freezing captured after the freezing step, respective values of the RGB color system to respective values of the L*a*b* color system, and to evaluate a freezing quality of the red fish meat on the basis of the respective values of the L*a*b* color system.

By converting, with respect to images of the red fish meat before freezing and after freezing captured before and after the freezing step, respective values of the RGB color system representing the light-source color to respective values of the L*a*b* color system representing the object's color, and analyzing a change in the object's color on the basis of the respective values as described above, it is possible to properly evaluate the freezing quality of the red fish meat by using an objective index.

In an embodiment, the system further comprises: a first capturing part disposed on an upstream side of the freezing part and configured to capture an image of the red fish meat before freezing; a third capturing part disposed on a downstream side of the refreezing part and configured to capture an image of the red fish meat after refreezing; and an appearance quality evaluating part configured to convert, with respect to an image of the red fish meat before freezing captured before the freezing step and an image of the red fish meat after freezing captured after the freezing step, respective values of the RGB color system to respective values of the L*a*b* color system, and to evaluate an appearance quality of the red fish meat on the basis of the respective values of the L*a*b* color system.

By converting, with respect to an image of the red fish meat before freezing captured before the freezing step and an image of the red fish meat after refreezing captured after the refreezing step, respective values of the RGB color system representing the light-source color to respective values of the L*a*b* color system representing the object's color as described above, and analyzing a change in the object's color on the basis of the respective values, it is possible to properly evaluate the appearance quality of the red fish meat by using an objective index.

A frozen red fish meat according to at least an embodiment of the present invention comprises: a superficial layer having an ice crystal area ratio of from 60% to 70%; and an inner portion present on an inner side than the superficial layer of the red fish meat and having an ice crystal area ratio of less than 60%, where the ice crystal area ratio is a ratio of an area of ice crystal in a unit area in a transverse cross-section of muscle fibers of the red fish meat.

In the above-described frozen red fish meat, the area of ice crystal in the superficial layer is larger than the area of ice crystal in the inner portion of the red fish meat, whereby it is possible to provide a good appearance color in line with the actual meat color of the red fish meat while maintaining a good freezing quality of the inner portion of the red fish meat. That is, when the ice crystal area ratio of the inner portion on the inner side of the superficial layer of the red fish meat is less than 60%, the inner portion of the red fish meat can be maintained in a frozen state by rapid freezing, and a high freezing quality can be maintained. On the other hand, when the ice crystal area ratio of the superficial layer of the red fish meat is from 60% to 70%, the superficial layer becomes in a frozen state by slow freezing, whereby it is possible to suppress clouding or opaquing of the superficial layer, thereby to improve the appearance quality of the frozen fish meat.

### Advantageous Effects

According to at least an embodiment of the present invention, it is possible to improve the appearance color of the red fish meat while maintaining the freezing quality. That is, by thawing the superficial layer of the red fish meat whole of which is frozen including the superficial layer and the inner core part, and refreezing the superficial layer of the red fish meat at a lower freezing speed than the freezing speed at the first freezing, it is possible to improve the clouding or opaquing of the superficial layer of the red fish meat and to bring the color of the frozen red fish meat close to the actual meat color. Accordingly, it is possible to improve the appearance color of the frozen red fish meat and thereby to obtain a proper evaluation in line with the actual fish meat quality in the marketing. Further, since only the superficial layer of the red fish meat is thawed, the frozen state of the inner portion of the red fish meat can be maintained, whereby it is possible to maintain a good freezing quality.

### BRIEF DESCRIPTION OF DRAWINGS

FIG. 1 is a flowchart of a process for producing a frozen fish meat according to an embodiment.

FIG. 2 is a schematic diagram illustrating a system for producing a frozen fish meat according to an embodiment.

FIG. 3 is a perspective view of salmon fillets placed on a mesh belt.

FIG. 4 is a cross-sectional view illustrating a mesh belt and a salmon fillet.

FIG. 5 is a chart showing a relationship between ice crystal area ratios and L* values.

FIG. 6 is a chart showing an example of environmental temperature surrounding a red fish meat and retention time.

FIG. 7 is a chart showing classes of frozen state of fillets of silver salmon obtained by principal component analysis based on the L*a*b* color system.

FIG. 8 is a chart showing an example of setting of the criterion values for fillets of silver salmon.

FIG. 9 is a chart showing a result of principal component analysis of farmed silver salmon, for an example.

FIG. 10 is a chart showing a result of principal component analysis of natural salmon, for an example.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

Now, a process for producing a frozen fish meat and a method for improving appearance color of a frozen fish meat according to some embodiments of the present invention will be described, and then a system for producing a frozen fish meat according to some embodiments will be described.

In this description, a “red fish meat” means a fish meat having a meat tinged with red or yellow color, such as salmon, tuna or bonito. Further, in this description, the red fish meat to be frozen or evaluated is one having a form such that at least a part of red meat is exposed so that the appearance color (surface color) of the red meat is visible, such as a fillet or dried fish.

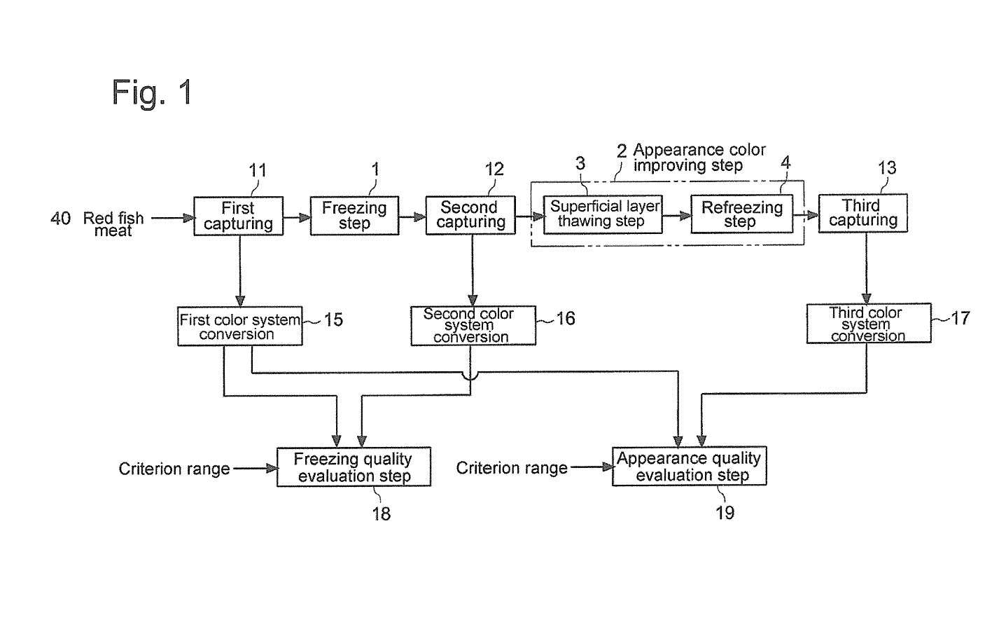

FIG. 1 is a flowchart of a process for producing a frozen fish meat according to an embodiment.

Firstly, a process for producing a frozen fish meat including a step of improving appearance color of a red fish meat will be described.

As shown in FIG. 1, a process for producing a frozen fish meat according to an embodiment include a freezing step 1, and an appearance color improving step 2 including a superficial layer thawing step 3 and a refreezing step 4.

In the freezing step 1, a red fish meat 40 is cooled to freeze a whole of the red fish meat 40 including the superficial layer and the inner core part. In this step, with a view to improving the freezing quality, the red fish meat 40 may be rapidly frozen. In the freezing step 1, cold air may be blown to a red fish meat 40 placed on a mesh belt made from a resin to rapidly freeze the red fish meat 40. The configuration of the resin mesh belt will be described later. In the freezing step 1, a high freezing speed is usually set in order to let the temperature rapidly go through the temperature zone of maximum ice crystal formation in the freezing process of the red fish meat 40. Thus, ice crystals which are formed from water in the red fish meat 40 when it is frozen may grow small, and the appearance color of the red fish meat 40 may become cloudy or opaque. In this regard, in this embodiment, a treatment to improve the clouding or opaquing of the red fish meat 40 is performed in the next step i.e. the appearance color improving step 2.

In the appearance color improving step 2 includes the superficial layer thawing step 3 and the refreezing step 4. In this step, the clouding or opaquing of the red fish meat 40 is suppressed to improve the appearance quality of the red fish meat 40.

In the superficial layer thawing step 3, the red fish meat 40 frozen in the freezing step 1 is heated from an outer side to thaw the superficial layer of the red fish meat 40. In the superficial layer thawing step 3, warm air is blown to the superficial layer of the red fish meat 40 to thaw the superficial layer. The superficial layer of the red fish meat 40 can thereby be thawed effectively in a short time. Then, when the superficial layer of the red fish meat 40 is thawed, the heating is stopped. In the superficial layer thawing step 3, at least a part of the ice crystal structure in the superficial layer, which is a cause of the clouding or opaquing of the red fish meat 40, is thawed.

In the refreezing step 4, the superficial layer of the red fish meat 40 thawed in the superficial layer thawing step is refrozen at a lower freezing speed than the freezing speed in the freezing step 1. In this step, the red fish meat 40 may be slowly frozen. In the refreezing step 4, a cold heat of an inner portion present on an inner side than the superficial layer of the red fish meat 40 may be used to refreeze the superficial layer, without actively blowing cold air to the red fish meat 40 from the outside. In the refreezing step 2, ice crystals are again formed in the superficial layer by refreezing water in the superficial layer of the red fish meat 40, where the ice crystals grow large as the freezing speed is low, and thus the red fish meat 40 displays red or yellow in appearance.

By the above-described process, it is possible to suppress the clouding or opaquing of the superficial layer of the red fish meat 40 and thereby to bring the color even of a frozen product of the red fish meat 40 closer to its actual meat color. Accordingly, it is possible to improve the appearance color of the frozen red fish meat and thereby to obtain a proper evaluation in line with the actual quality of the fish meat in the marketing. Further, since only the superficial layer of the red fish meat 40 is thawed in the superficial layer thawing step 3, it is possible to maintain the frozen state of the inner portion of the red fish meat 40 and to maintain a high freezing quality. Further, since only the superficial layer of the red fish meat 40 is thawed in the superficial layer thawing step 1, it is possible to maintain the frozen state of the inner portion of the red fish meat 40 and to maintain a high freezing quality.

Now, a production process including a step of evaluation the red fish meat will be described.

In another embodiment, the production process of the red fish meat may include, as shown in FIG. 1, at least one of a freezing quality evaluation step 18 or an appearance quality evaluation step 19.

In the freezing quality evaluation step 18, the freezing quality of the frozen red fish meat is evaluated from captured images of the red fish meat 40. That is, in the freezing quality evaluation step 18, respective values of the RGB color system are obtained from an image of the red fish meat 40 before freezing captured in a first capturing (step) 11 before the freezing step 1 and an image of the red fish meat 40 after freezing captured in a second capturing (step) 12 after the freezing step 1. Then, in a first color system conversion (step) 15, the respective values of the RGB color system of the image before freezing are converted into respective values of the L*a*b* color system. Likewise, in a second color system conversion (step) 16, the respective values of the RGB color system of the image after freezing is converted into respective values of the L*a*b* color system. Then, in the freezing quality evaluation step 18, the freezing quality of the red fish meat 40 is evaluated on the basis of the respective values of the L*a*b* color system obtained by the conversion. In the freezing quality evaluation step 18, whether the freezing is good or bad may be judged by using an analysis method such as the principal component analysis.

By converting, with respect to images of the red fish meat 40 before freezing and after freezing captured before and after the freezing step 1, respective values of the RGB color system representing the light-source color to respective values of the L*a*b* color system representing the object's color, and analyzing a change in the object's color on the basis of the respective values as described above, it is possible to properly evaluate the freezing quality of the red fish meat 40 by using an objective index.

In the appearance quality evaluation step 19, the appearance quality of the frozen red fish meat is evaluated from captured images of the red fish meat 40. That is, in the appearance quality evaluation step 19, respective values of the RGB color system are obtained from an image of the red fish meat 40 before freezing captured in the first capturing (step) 11 before the freezing step 1 and an image of the red fish meat 40 after refreezing captured in a third capturing (step) 13 after the refreezing step 4. Then, in a first color system conversion (step) 15, the respective values of the RGB color system of the image before freezing are converted into respective values of the L*a*b* color system. Likewise, in a third color system conversion (step) 17, the respective values of the RGB color system of the image after refreezing is converted into respective values of the L*a*b* color system. Then, in the appearance quality evaluation step 19, the appearance quality of the red fish meat 40 is evaluated on the basis of the respective values of the L*a*b* color system obtained by the conversion. In the appearance quality evaluation step 19, whether the appearance is good or bad may be judged by using an analysis method such as the principal component analysis.

By converting, with respect to an image of the red fish meat 40 before freezing captured before the freezing step 1 and an image of the red fish meat 40 after refreezing captured after the refreezing step 4, respective values of the RGB color system representing the light-source color to respective values of the L*a*b* color system representing the object's color as described above, and analyzing a change in the object's color on the basis of the respective values, it is possible to properly evaluate the appearance quality of the red fish meat 40 by using an objective index.

In an embodiment, the evaluation result obtained in the freezing quality evaluation step 18 may be used as feedback in the operation control in the freezing step 1. Likewise, the evaluation result obtained in the appearance quality evaluation step 19 may be used as feedback in the operation control in the appearance color improving step 2. By using the evaluation results as feedback in the operation control, it is possible to perform operation control more suitable to obtain high-quality frozen fish meat.

In some embodiments, the method for improving appearance color of a red fish meat may include the steps described below in order to improve the appearance color of an existing frozen red fish meat obtained by rapid freezing.

The method for improving appearance color of a frozen fish meat includes a superficial layer thawing step and a refreezing step.

In the superficial layer thawing step, a frozen red fish meat which is wholly frozen including the superficial layer and the inner core part is heated from an outer side to thaw the superficial layer of the red fish meat. Detail description of the superficial layer thawing step will be omitted because it is substantially the same as the above-described superficial layer thawing step 3.

In the refreezing step 4, the superficial layer of the red fish meat thawed in the superficial layer thawing step 3 is refreeze at a lower freezing speed than the freezing speed in the freezing step 1. Detail description of the refreezing step will be omitted because it is substantially the same as the above-described refreezing step 4.

In the above-described method for improving appearance color of a frozen fish meat, the superficial layer of the red fish meat obtained by rapid freezing is thawed in the superficial layer thawing step, and then the superficial layer of the red fish meat is slowly frozen in the refreezing step, whereby the clouding or opaquing of the superficial layer of the red fish meat can be suppressed, and it is possible to bring the color even of a frozen product of the red fish meat closer to its actual meat color. Accordingly, it is possible to improve the appearance color of the frozen red fish meat and to obtain proper evaluation in accordance with the quality of the actual fish meat in the marketing. Further, since only the superficial layer of the red fish meat is thawed in the superficial layer thawing step, it is possible to maintain the frozen state of the inner portion of the red fish meat and thereby to maintain a good freezing quality.

In an embodiment, it may be that in the freezing step 1, the red fish meat 40 is frozen through to the inner portion so that the ice crystal area ratio of the superficial layer of the red fish meat 40 becomes less than 60%, and in the refreezing step 4, the red fish meat 40 is refrozen so that the ice crystal area ratio of the superficial layer of the red fish meat 40 becomes at least 60% and at most 70%. In such a case, it may be that, in each of the freezing quality evaluation step 18 and the appearance quality evaluation step 19, the ice crystal area ratio of the superficial layer of the frozen (or refrozen) red fish meat 40 is measured, and the measured ice crystal area ratios are used as feedback in the freezing step 1 or the refreezing step 4 to control the freezing.

The “ice crystal area ratio” in this description is a value expressed in percentage of the area of ice crystals in a unit area in a transverse cross-section of muscle fibers of the red fish meat 40.

In the frozen product of the red fish meat 40 obtained by carrying out the above freezing method, the ice crystal area ratio in the superficial layer 41 of the red fish meat 40 is at least 60% and at most 70%, and the ice crystal area ratio in the inner portion 42, including the inner core part, at the inner side than the superficial layer 41 of the red fish meat 40 is less than 60% (see FIG. 4).

Here, an influence of the ice crystal area ratio in the red fish meat 40 on the appearance quality or the freezing quality of the red fish meat 40 will be described with reference to FIG. 5. FIG. 5 is a chart showing a relationship between the ice crystal area ratios and the L* values. As seen in FIG. 5, in the region A where the ice crystal area ratio of the red fish meat 40 is at least 45% and less than 53%, for example, the L* value indicating lightness is large. That is, this suggests that remarkable clouding arises in the region A. In the region B where the ice crystal area ratio of the red fish meat 40 is at least 53% and less than 60%, the L* value is still relatively large although it is lower than in the region A, and some clouding can be seen. Here, if the ice crystal area ratio is small, it suggests that the freezing quality is good. On the other hand, in the region C where the ice crystal area ratio is at least 60%, the L* value is about 50%, which is low, and a good color can be seen. Accordingly, it is considered that the appearance quality is good in the region C where the ice crystal area ratio of the red fish meat 40 is at least 60%.

Thus, by allowing the ice crystal area ratio of the inner portion on the inner side of the superficial layer 41 of the red fish meat 40 to be less than 60%, the inner portion 42 of the red fish meat 40 can be maintained in a frozen state of rapid freezing, and a high freezing quality can be maintained. On the other hand, by allowing the ice crystal area ratio of the superficial layer 41 of the red fish meat 40 to be from 60% to 70%, the superficial layer 41 becomes in a frozen state of slow freezing, whereby it is possible to suppress clouding or opaquing of the superficial layer 41 of the red fish meat 40, thereby to improve the appearance quality of the frozen product. Accordingly, it is possible to provide a good appearance color in accordance with the actual meat color of the red fish meat 40 while maintaining the freezing quality of the inner portion 42 of the red fish meat 40.

In another embodiment, it may be that in the freezing step 1, the red fish meat 40 is frozen through to the inner portion 42 so that the averaged diameter of equivalent circles in the superficial layer 41 of the red fish meat 40 becomes at most 50 μm, and in the refreezing step 4, the red fish meat 40 is refrozen so that the averaged diameter of equivalent circles in the superficial layer 41 of the red fish meat 40 becomes at least 70 μm and at most 150 μm. In such a case, it may be that, in each of the freezing quality evaluation step 18 and the appearance quality evaluation step 19, the averaged diameter of equivalent circles in the superficial layer 41 of the frozen (or refrozen) red fish meat 40 is measured, and the measured averaged diameter of equivalent circles is used as feedback in the freezing step 1 or the refreezing step 4 to control the freezing.

In this description, the “averaged diameter of equivalent circles” means an averaged value of diameters of the equivalent circles, each calculated as a diameter of the equivalent circle having the same area as an ice crystal area, in the transverse cross-section of the muscle fibers of the red fish meat 40.

In the frozen product of the red fish meat 40 obtained by carrying out the above freezing method, the averaged diameter of equivalent circles in the superficial layer 41 of the red fish meat 40 is from 70 μm to 150 μm, and the averaged diameter of equivalent circles in the inner portion 42, including the inner core part, at the inner side than the superficial layer 41 of the red fish meat 40 is at most 50 μm.

Thus, since the ice crystal area in the superficial layer 41 of the red fish meat 40 is larger than the ice crystal area in the inner portion 42 of the red fish meat 40, it is possible to provide a good appearance color in accordance with the actual meat color of the red fish meat 40 while maintaining a high freezing quality of the inner portion 42 of the red fish meat 40. That is, by allowing the averaged diameter of equivalent circles in the inner portion 42 of the red fish meat to be at most 50 μm, it is possible to maintain the inner portion 42 of the red fish meat 40 in a state of rapid freezing, which suggests that a high freezing quality is maintained. On the other hand, by allowing the averaged diameter of equivalent circles in the superficial layer 41 of the red fish meat 40 to be at least 70 μm and at most 150 μm, the superficial layer 41 become in a frozen state by a slow freezing, whereby it is possible to suppress clouding or opaquing in the superficial layer 41 of the red fish meat 40, and thereby to improve the appearance quality of the frozen product.

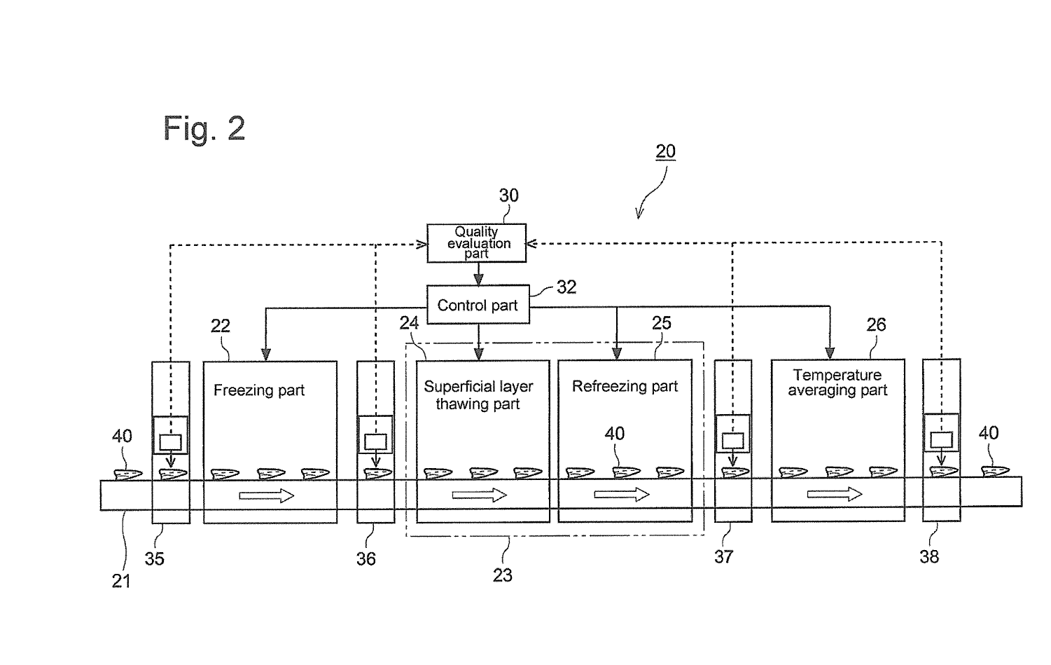

FIG. 2 is a schematic diagram illustrating a system for producing a frozen fish meat according to an embodiment.

As illustrated in FIG. 2, in an embodiment, a system 20 for producing a frozen fish meat includes a conveyer 21 for conveying a red fish meat 40, a freezing part 22 for freezing the red fish meat 40, and an appearance color improving part 23 including a superficial layer thawing part 24 and a refreezing part 25, for improving an appearance color of the red fish meat 40.

In some embodiment, the conveyer 21 has a structure on which a red fish meat 40 can be placed, and extends through the freezing part 22, the superficial layer thawing part 24 and the refreezing part 25. The red fish meat 40 placed on the conveyer 21 is conveyed through the freezing part 22, the superficial layer thawing part 24 and the refreezing part 25, in this order.

The freezing part 22 is disposed on an upstream side on the conveyer 21 and cools the red fish meat 40 to freeze the whole of the red fish meat 40 including the superficial layer and the inner core part. For example, the freezing part 22 may be a continuous freezer having a freezing box through which the conveyer 21 moves, and a cold air supply means for blow cold air from an upper part and a lower part to the red fish meat 40 placed on the conveyer 21. The temperature in the cold air may be from −50° C. to −30° C. The staying time of the red fish meat 40 in the box may be at least 20 minutes and at most 50 minutes.

The superficial layer thawing part 24 is disposed on a downstream side of the freezing part 22 on the conveyer 21 and thaws the superficial layer of the red fish meat 40 by heating the red fish meat 40 from the outside. For example, the superficial layer thawing part 24 may be a warm air impinging jet apparatus having a thawing box through which the conveyer 21 moves, and a warm air supply means for blowing warm air from at least one of the upper part or the lower part to the red fish meat 40 placed on the conveyer 21. In a case of red fish meat 40 with skin, the warm air may be blown only from the side where the red meat is exposed. The temperature of the warm air may be from 20° C. to 50° C. Staying time of the red fish meat 40 may be at least 30 seconds and at most 3 minutes.

The refreezing part 25 refreeze the superficial layer of the red fish meat 40 thawed in the superficial layer thawing part 24 at a lower freezing speed than the freezing speed in the freezing part 22. For example, the refreezing part 25 may include a refreezing box through which the conveyer 21 moves, and a cold air supply means for blowing clod air to the red fish meat 40 placed on the conveyer 21 at least from a side on which the red fish meat 40 is thawed in the superficial layer thawing part 24. Or the refreezing part 25 may have a structure like a typical frozen product storage or a temperature averaging box for averaging temperature of frozen red meat, and it may not have a means for actively blowing cold air. In this case, the superficial layer is refrozen mainly by heat transfer of cold heat from the inner portion of the red fish meat 40. The superficial layer can thereby easily be refrozen at a lower freezing speed than the freezing speed in the freezing part 22. Further, since refreezing in a typical frozen product storage or a temperature averaging box for averaging temperature of red fish meat becomes possible, it is possible to reduce the facility cost.

By using the above system 20 for producing frozen fish meat, it is possible to improve the appearance color while maintaining the freezing quality of the red fish meat 40. That is, in the system 20 for producing frozen fish meat, after freezing the red fish meat 40 by the freezing part 22, the superficial layer of the red fish meat 40 is thawed by the superficial layer thawing part 24, and the superficial layer of the red fish meat 40 is refrozen by the refreezing part 25. In the refreezing part 25, the superficial layer is refrozen at a lower freezing speed than the freezing speed in the freezing part 22. It is thereby possible to improve clouding or opaquing in the superficial layer of the red fish meat 40, and thereby to bring the color even of a frozen product of the red fish meat 40 to its actual meat color. Accordingly, it is possible to improve the appearance color of the frozen red fish meat, and thereby to obtain a proper evaluation in line with the actual fish meat quality in the marketing. Further, since only the superficial layer of the red fish meat 40 is thawed by the superficial layer thawing part 24, it is possible to maintain the inner portion of the red fish meat 40 and thereby to maintain a high freezing quality.

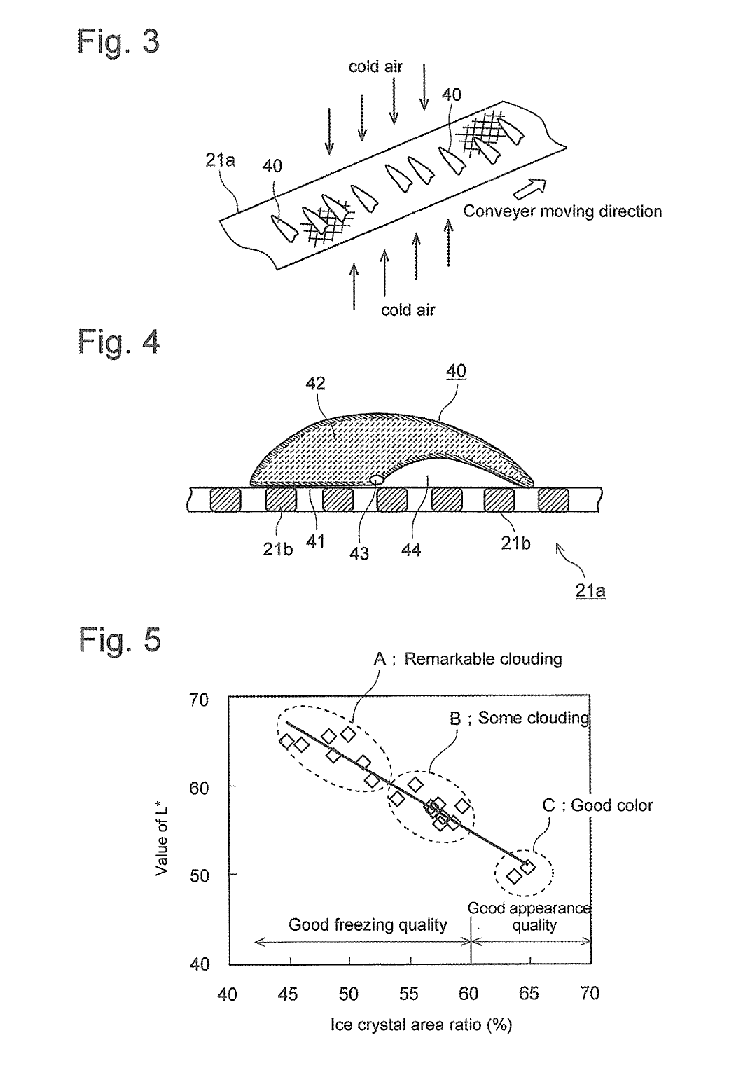

In an embodiment, as illustrated in FIG. 3 and FIG. 4, the conveyer 21 may include a mesh belt 21a made from a resin to place the red fish meat 40. In this description, the superficial layer 41 of the red fish meat 40 shown in FIG. 4 is a portion having a thickness from the surface exposed to the outside toward the inner side to such an extent that the thickness contributes to the appearance color, and the inner portion 42 is a portion on the inner side than the superficial layer 41, including the inner core part in the vicinity of the central bone 43.

As illustrated in FIG. 3, the red fish meat 40 placed on the mesh belt 21a made from a resin is cooled by cold air blown from the upper side and the lower side. Thus the cold air passes through the openings of the mesh belt 21a and is directly blown onto the red fish meat 40, whereby it is possible to increase the freezing speed. For example, as shown in FIG. 4, a fillet 40 of silver salmon forms a space 44 on a side of the central bone 43, the space 44 formed by removing the internal organs. At the time of freezing, the silver salmon 40 is usually placed on the conveyer 21 with the skin side up for the purpose of maintaining the shape of the fish meat. When a belt conveyer having a flat shape is used, the space 44 is located between the belt conveyer and the red fish meat 40. In such a case, there may be a problem such that the freezing speed of the red fish meat 40 near the space 44 may be decreased. Thus, by using a mesh belt 21a made from a resin, it is possible to effectively cool a fillet of the red fish meat 40 even when the space 44 is present.

Further, since the mesh belt 21a made from a resin has a lower thermal conductivity than a metal, the temperature difference between the portion of the red fish meat 40 which is in contact with the mesh belt 21a and the portion of the red fish meat 40 which is positioned above the openings can be decreased, whereby it is possible to avoid mesh print remaining on a portion of the red fish meat 40 at a side in contact with the mesh belt 21a. Further, as shown in the cross section 21b of the mesh in FIG. 4, the mesh belt 21a made from a resin may have a substantially flat surface to be in contact with the red fish meat. It is thereby possible to suppress generation of a concave or a convex due to the self-weight of the red fish meat 40.

With reference to FIG. 2 again, in an embodiment, the system 20 for producing the frozen fish meat may have a temperature averaging part 26 for the purpose of further improving the freezing quality. The temperature averaging part 26 is disposed on a downstream side of the refreezing part 25 and is configured to average the temperature of the frozen red fish meat. In this part, the temperature of the red fish meat 40, including the superficial layer and the inner core part, becomes substantially uniform. It may be that the temperature averaging part 26 is configured to fulfill the role of the refreezing part 25. In such a case, the appearance color improving part 23 includes the superficial layer thawing part 24 and the refreezing part 25 composed of the temperature averaging part 26. For example, the inside temperature of the temperature averaging part 26 may be from −10° C. to 0° C. The staying time of the red fish meat 40 in the box may be at least 1 hour.

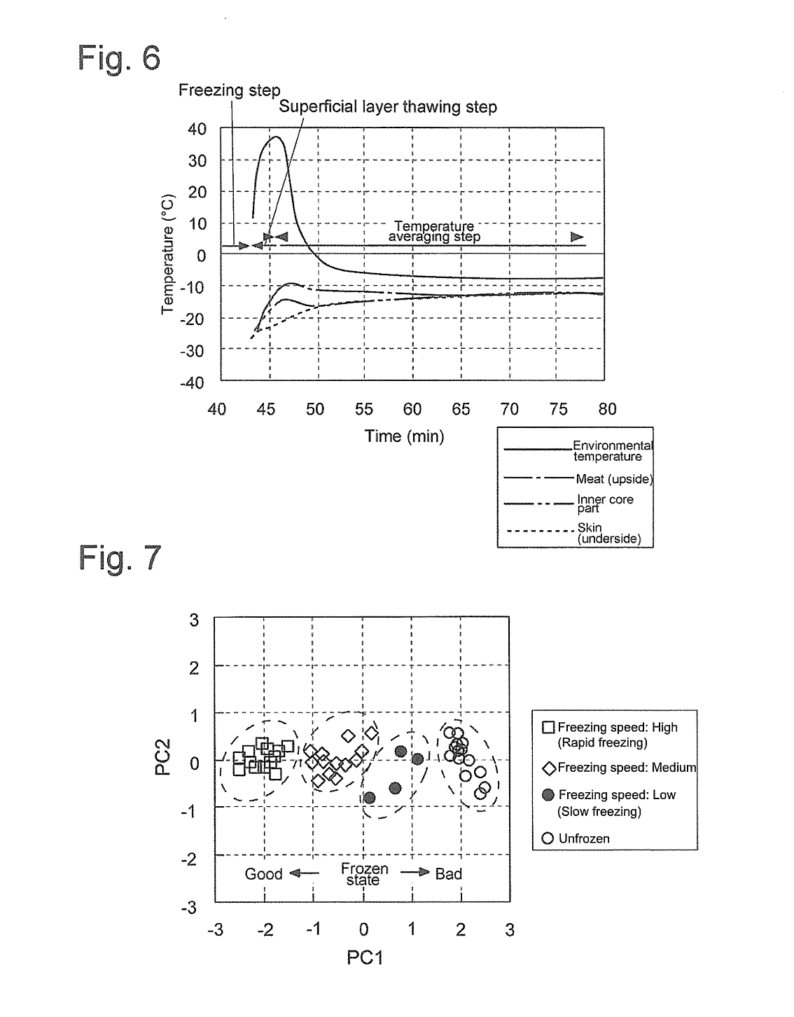

Now, an example of environmental temperature surrounding the red fish meat 40 and the retention time will be described with reference to FIG. 6. In the graph of FIG. 6, the cooling step is omitted.

As shown in the graph of FIG. 6, the red fish meat 40 frozen at an environmental temperature of about −35° C. is retained under an environmental temperature of about 40° C. for about 2 minutes in the superficial layer thawing step to increase the temperature of the superficial layer. In this example, the red fish meat 40 is placed on the conveyer 21 with the meat side up on which the red meat is exposed and with the skin side down, and warm air is blown from the meat side. By placing the red fish meat 40 with the meat side up and with the skin side down (i.e. the skin side is closer to the mesh belt) when the warm air is blown thereto, the meat is less likely to be affected by the heat of them mesh belt, whereby it is possible to further improve the quality of the frozen product.

In an embodiment, as shown in FIG. 2, the system 20 for producing a frozen fish meat may further include a quality evaluation part 30, control part 32, a first capturing part 35, a second capturing part 36, a third-A capturing part 37 and a third-B capturing part 38.

The first capturing part 35 is provided on an upstream side of the freezing part 22 and captures an appearance of the red fish meat 40 placed on the conveyer 21 to obtain an image of the red fish meat 40 before freezing. The upstream side in this context is the upstream side with respect to the conveying direction by the conveyer 21. On the other hand, the downstream side in this context is the downstream side with respect to the conveying direction by the conveyer 21.

The second capturing part 36 is provided between the freezing part 22 and the superficial layer thawing part 24, and captures an appearance of the red fish meat 40 after frozen by the freezing part 22 to obtain an image of the red fish meat 40 after freezing.

The third-A capturing part 37 is provided on a downstream side of the refreezing part 25 and, and captures an appearance of the red fish meat refrozen by the refreezing part 25 to obtain an image of the red fish meat 40 after refreezing.

The third-B capturing part 38 is provided on a downstream side of the temperature averaging part 26, and captures an appearance of the red fish meat after temperature averaging by the temperature averaging part 26 to obtain an image of the red fish meat 40 after the temperature averaging.

For example, digital cameras are used for the first capturing part 35, the second capturing part 36, the third-A capturing part 37 and the third-B capturing part 38. With a view to suppressing influence on the images by internal diffusion of light within the red fish meat 40, the digital cameras are installed so as not to be in contact with the red fish meat 40.

It may be that only one of the third-A capturing part 37 or the third-B capturing part is provided.

The quality evaluation part 30 includes at least one of a freezing quality evaluation part or an appearance quality evaluation part.

The freezing quality evaluation part evaluates the freezing quality of the frozen red fish meat from captured images of the red fish meat 40. That is, the freezing quality evaluation obtains respective values of the RGB color system from an image of the red fish meat 40 before freezing captured by the first capturing part 35 and an image of the red fish meat 40 after freezing captured by the second capturing part 36. Then, it converts the respective values of the RGB color system of the images before freezing and after freezing are converted into respective values of the L*a*b* color system. Then, it evaluates the freezing quality of the red fish meat 40 on the basis of the respective values of the L*a*b* color system obtained by the conversion. The freezing quality evaluation part may be configured to judge whether the freezing is good or bad by using an analysis method such as the principal component analysis.

By converting, with respect to images of the red fish meat 40 before freezing and after freezing captured on the upstream side and the downstream side of the freezing part 22, respective values of the RGB color system representing the light-source color to respective values of the L*a*b* color system representing the object's color, and analyzing a change in the object's color on the basis of the respective values as described above, it is possible to properly evaluate the freezing quality of the red fish meat 40 by using an objective index.

The appearance quality evaluation part evaluates the appearance quality of the frozen red fish meat from captured images of the red fish meat 40. That is, the appearance quality evaluation part obtains respective values of the RGB color system from the image of the red fish meat 40 before freezing captured by the first capturing part 35 and the image of the red fish meat 40 after refreezing captured by at least one of the third-A capturing part 37 or the third-B capturing part 38. Then, it converts the respective values of the RGB color system of the images before freezing and after refreezing into respective values of the L*a*b* color system. Then, it evaluates the appearance quality of the red fish meat 40 on the basis of the respective values of the L*a*b* color system obtained by the conversion. The appearance quality evaluation part may be configured to judge whether the appearance is good or bad by using an analysis method such as the principal component analysis.

By converting, with respect to an image of the red fish meat 40 before freezing captured on the upstream side of the freezing part 22 and an image of the red fish meat 40 after refreezing captured on the downstream side of the refreezing part 25, respective values of the RGB color system representing the light-source color to respective values of the L*a*b* color system representing the object's color as described above, and analyzing a change in the object's color on the basis of the respective values, it is possible to properly evaluate the appearance quality of the red fish meat 40 by using an objective index.

The control part 32 controls at least one of the freezing part 22, the superficial layer thawing part 24, the refreezing part 25 or the temperature averaging part 26 by using feedback based on the evaluation results obtained by the quality evaluation part 30. By performing operation control by using the evaluation results obtained by the quality evaluation part 30 as feedback by the control unit 32, it is possible to perform more appropriate operation control to obtain a high-quality frozen fish meat.

### Example 1

### Relation Between Freezing Quality and Appearance Color

Evaluation test was carried out for evaluating the appearance colors of unfrozen silver salmon and salon frozen at various speeds by using silver salmon farmed in production area A. FIG. 7 is a chart showing analysis results of principal component analysis of values of the L*a*b* color system converted from obtained image before freezing of an unfrozen silver salmon and obtained image after freezing of a silver salmon frozen at various speeds. As seen from FIG. 7, it became evident that the value of the first primary component becomes small when the freezing speed increases, and when the freezing speed becomes lower, the value of the first primary component becomes closer to that of unfrozen silver salmon. Here, with respect to the primary component, the L* value was negative, and the a* and b* values were positive. Therefore, it became evident that when the first primary component is small, the appearance color (surface color) is pale and dusky, that is the appearance color is clouded. When a meat to be frozen is rapidly frozen, fine ice crystals are formed in the superficial layer, and diffuse reflection on the surface and diffuse reflection in the superficial layer, i.e. so-called irregular reflection becomes intense, and white is intensely detected overall. Thus, the degree of increase in the L* value and decrease in the a* value and b*value, on which the freezing speed depends, is effective as an objective means to judge whether the freezing is good or bad. If only absolute values of L*a*b* are used to the judge, it may be strongly influenced by change in the material color before freezing due to the season variation, production area or quality of feed. Thus, by employing the principal component analysis, it is possible to evaluate taking the relative variation into consideration.

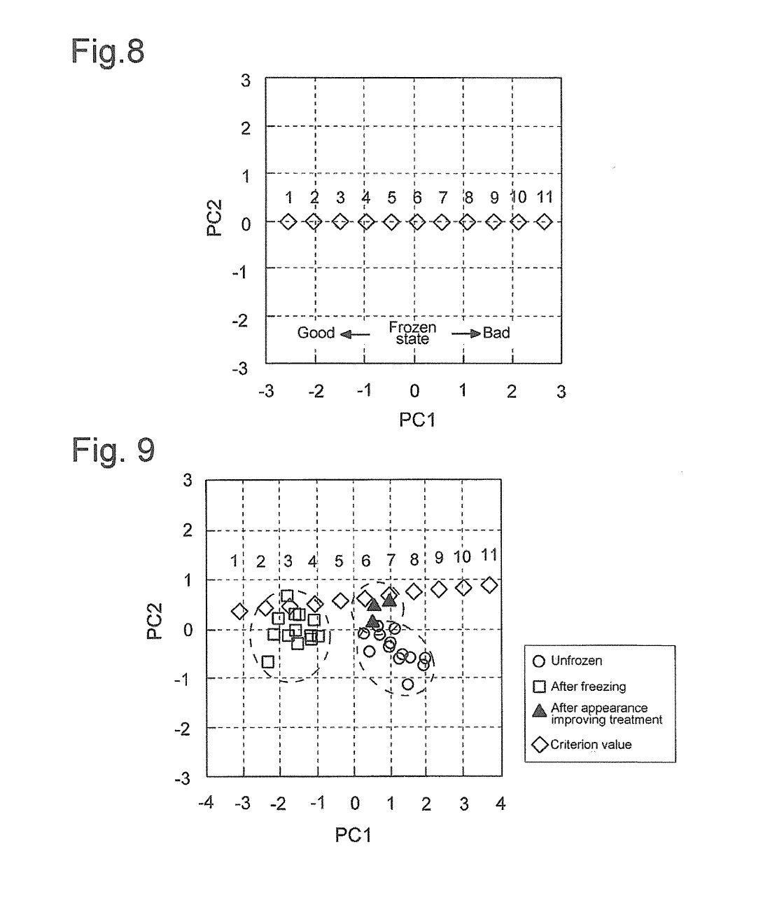

On the basis of the results of the change in the surface color shown in FIG. 7, normalization of the surface color was carried out. By inversely calculating the L*a*b* values from the graph of FIG. 7 and an approximate formula, an index value can be selected on a voluntary basis. The results are shown in FIG. 8. FIG. 8 is a chart showing an example of setting of the criterion values for fillets of silver salmon. From FIG. 7 and FIG. 8, the criterion values for the class of “Freezing speed: High” are 1 to 3, the criterion values for the class of “Freezing speed: Medium” are 4 to 6, and the criterion values for the class of “Freezing speed: low” are 7 to 8, and the criterion value of 2, which is the intermediate value for the class of the highest freezing speed, is set to be the target value of the frozen surface color. Thus, it is preferred that the criterion range indicating a good frozen state of a fillet of silver salmon is set to be at most 5.

In this Example, the index value was calculated on the basis of the actual measurement value in the freezing speed test. However, the index value may be obtained from e.g. SalmoFan (registered trademark) or a salmon color chart. In such a case, another criterion range than that in this Example may be needed. Further, silver salmon is used in this Example; however, also for other salmons, the same evaluation may be carried out by setting suitable criterion ranges depending on the species.

### Example 2

### Appearance Quality Evaluation after Freezing and Appearance Improvement Treatment of Farmed Silver Salmon

By using silver salmon farmed in the production area A, an appearance quality evaluation after the freezing evaluation and an appearance improvement treatment was carried out. The appearance improvement treatment was such that a fillet after freezing was partially thawed, that is, only the superficial layer was thawed by warm air treatment for a short time, and then again the fillet was slowly frozen. The measured L*a*b* values before freezing, after freezing and after appearance improvement treatment, and the results of the principal component analysis based on the criterion valued obtained by FIG. 8, are shown in FIG. 9. The results show that a good appearance improvement treatment was performed because the index value for freezing is not more than 4, that is, the index value for one after the appearance improvement treatment is equivalent to the value for one which was unfrozen (before freezing). Further, the results show that the appearance quality was in a good state while a good freezing quality of the inner portion was maintained.

### Example 3

### Appearance Quality Evaluation after Freezing and Appearance Improvement Treatment of Natural Silver Salmon

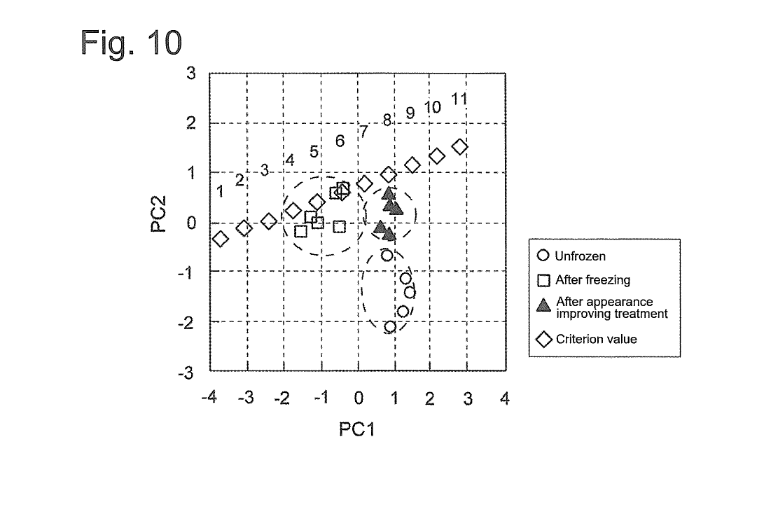

By using silver salmon farmed in production area B, an appearance quality evaluation after the freezing evaluation and an appearance improvement treatment was carried out. The appearance improvement treatment was carried out in the same manner as in Example 2. The measured L*a*b* values before freezing, after freezing and after appearance improvement treatment, and the results of the principal component analysis based on the criterion valued obtained by FIG. 8, are shown in FIG. 10. According to the results, the freezing quality of the salmon farmed in the production area B was basically good, but freezing defect was found for some fillets. Further, the results show that a good appearance improvement treatment was performed because the index value for one after the appearance improvement treatment was equivalent to the value for one which is unfrozen (before freezing). As described above, by employing the evaluation method according to the Examples, it is possible to perform an objective, quantitative and appropriate evaluation on whether the frozen state or the appearance improvement treatment is good or not, even with respect to silver salmons having different properties such as production areas or whether it is natural or farmed. The criterion index may be set for each production area or for natural ones or for farmed ones, whereby it is possible to perform more appropriate evaluation.

As described above, according to the above-described embodiments, it is possible to improve the appearance color while maintaining the freezing quality of the red fish meat 40. That is, by thawing the superficial layer 41 of the red fish meat 40 which is frozen including the superficial layer 41 and the inner core part, and refreezing the superficial layer 41 of the red fish meat 40 at a lower freezing speed than the freezing speed at the first freezing, clouding or opaquing in the superficial layer 41 of the red fish meat 40 can be improved, whereby it is possible to bring the color even of a frozen product of the red fish meat 40 closer to its actual meat color. Accordingly, it is possible to improve the appearance color of the frozen red fish meat and thereby to obtain a proper evaluation in line with the actual quality of the fish meat in the marketing. Further, since only the superficial layer 41 of the red fish meat 40 is thawed, it is possible to maintain the frozen state of the inner portion 42 of the red fish meat 40 and to maintain a high freezing quality.

Embodiments of the present invention were described in detail above, but the present invention is not limited thereto, and various amendments and modifications may be implemented within a scope that does not depart from the present invention.

### REFERENCE SIGNS LIST

1 Freezing step
2 Appearance color improving step
3 Superficial layer thawing step
4 Refreezing step
18 Freezing quality evaluation step
19 Appearance quality evaluation step
20 Production system for frozen fish meat
21 Conveyer
21a Mesh belt
21b Mesh cross-section
22 Freezing part
23 Appearance color improving part
24 Superficial layer thawing part
25 Refreezing part
26 Temperature averaging part
30 Quality evaluation part
32 Control part
35 First capturing part
36 Second capturing part
37 Third-A capturing part
38 Third-B capturing part
40 Red fish meat
41 Superficial layer
42 Inner portion
43 Central bone
44 Space

1. A process for producing a frozen fish meat for producing a frozen red fish meat, comprising:
a freezing step of cooling a red fish meat and freezing a whole of the red fish meat including a superficial layer and an inner core part;
a superficial layer thawing step of heating the red fish meat frozen in the freezing step from an outer side to thaw the superficial layer of the red fish meat; and
a refreezing step of stopping heating the red fish meat after the superficial layer is thawed in the superficial layer thawing step, and then refreezing the superficial layer of the red fish meat at a lower freezing speed than a freezing speed in the freezing step.

2. The process for producing a frozen fish meat according to claim 1, wherein in the superficial layer thawing step, warm air is blown to the superficial layer of the red fish meat to thaw the superficial layer.

3. The process for producing a frozen fish meat according to claim 1, wherein in the refreezing step, the superficial layer is refrozen by using a cold heat of an inner portion present on an inner side than the superficial layer of the red fish meat, without blowing cold air to the red fish meat.

4. The process for producing a frozen fish meat according to claim 1, wherein in the freezing step, cold air is blown to the red fish meat placed on a mesh belt made from a resin to rapidly freeze the red fish meat.

5. The process for producing a frozen fish meat according to claim 1, further comprising a freezing quality evaluation step of converting, with respect to an image of the red fish meat before freezing captured before the freezing step and an image of the red fish meat after freezing captured after the freezing step, respective values based on the RGB color system to respective values based on the L*a*b* color system, and evaluating a freezing quality of the red fish meat on the basis of the respective values based on the L*a*b* color system.

6. The process for producing a frozen fish meat according to claim 1, further comprising an appearance quality evaluation step of converting, with respect to an image of the red fish meat before freezing captured before the freezing step and an image of the red fish meat after refreezing captured after the refreezing step, respective values based on the RGB color system to respective values based on the L*a*b* color system, and evaluating an appearance quality of the red fish meat on the basis of the respective values based on the L*a*b* color system.

7. A method for improving an appearance color of a frozen fish meat for improving an appearance color of a frozen red fish meat obtained by rapid freezing, comprising:
a superficial layer thawing step of heating the red fish meat frozen wholly including a superficial layer and an inner core part from an outer side to thaw the superficial layer of the red fish meat; and
a refreezing step of stopping heating the red fish meat after the superficial layer is thawed in the superficial layer thawing step, and then slowly refreezing the superficial layer of the red fish meat.

8. A system for producing a frozen fish meat for producing a frozen red fish meat, comprising:
a conveyer for conveying a red fish meat;
a freezing part disposed on an upstream side on the conveyer, for cooling the red fish meat to freeze a whole of the red fish meat including a superficial layer and an inner core part;
a superficial layer thawing part disposed on a downstream side of the freezing part on the conveyer, for heating the red fish meat from an outer side to thaw the superficial layer of the red fish meat; and
a refreezing part for refreezing the superficial layer of the red fish meat thawed in the superficial layer thawing part at a lower freezing speed than a freezing speed in the freezing part.

9. The system for producing a frozen fish meat according to claim 8, wherein the superficial layer thawing part is configured to blow warm air to the superficial layer of the red fish meat to thaw the superficial layer.

10. The system for producing a frozen fish meat according to claim 8, wherein the refreezing part is configured to refreeze the superficial layer by using a cold heat of an inner portion present on an inner side than the superficial layer of the red fish meat, without blowing cold air to the red fish meat.

11. The system for producing a frozen fish meat according to claim 8,
wherein the conveyer includes a mesh belt made from a resin, on which the red fish meat is placed, and
wherein the freezing part includes a cold air supply part for blowing cold air to the red fish meat placed on the mesh belt.

12. The system for producing a frozen fish meat according to claim 8, further comprising:
a first capturing part disposed on an upstream side of the freezing part and configured to capture an image of the red fish meat before freezing;
a second capturing part disposed on a downstream side of the freezing part and configured to capture an image of the red fish meat after freezing; and
a freezing quality evaluating part configured to convert, with respect to an image of the red fish meat before freezing captured before the freezing step and an image of the red fish meat after freezing captured after the freezing step, respective values of the RGB color system to respective values of the L*a*b* color system, and to evaluate a freezing quality of the red fish meat on the basis of the respective values of the L*a*b* color system.

13. The system for producing a frozen fish meat according to claim 8, further comprising:
a first capturing part disposed on an upstream side of the freezing part and configured to capture an image of the red fish meat before freezing;
a third capturing part disposed on a downstream side of the refreezing part and configured to capture an image of the red fish meat after refreezing; and
an appearance quality evaluating part configured to convert, with respect to an image of the red fish meat before freezing captured before the freezing step and an image of the red fish meat after freezing captured after the freezing step, respective values of the RGB color system to respective values of the L*a*b* color system, and to evaluate an appearance quality of the red fish meat on the basis of the respective values of the L*a*b* color system.

14. A frozen red fish meat comprising:
a superficial layer having an ice crystal area ratio of from 60% to 70%; and
an inner portion present on an inner side than the superficial layer of the red fish meat and having an ice crystal area ratio of less than 60%,
wherein the ice crystal area ratio is a ratio of an area of ice crystal in a unit area in a transverse cross-section of muscle fibers of the red fish meat.
